(19) United States
(12) Patent Application Publication
(10) Pub. No.: US 2026/0337025 A1
(43) Pub. Date: Oct. 29, 2026

(54) MICROWAVE-ASSISTED FABRICATION OF SUBMICRON CARBONATE APATITE POWDERS

(71) Applicant: Ajman University, AJman (AE)

(72) Inventors: Arief Cahyanto, Ajman (AE); Deby Fajar Mardhian, Ajman (AE); Myrna Nurlatifah Zakaria, Kuala Lumpar (MY); Vinay Sivaswamy, Ajman (AE)

(73) Assignee: Ajman University, Ajman (AE)

(21) Appl. No.: 19/186,736

(22) Filed: Apr. 23, 2025

(51) Int. Cl. C01B 25/455

(52) U.S. Cl. CPC C01B 25/455; C01P 2004/22; C01P 2006/80

(57) ABSTRACT

A method includes preparing a solution of disodium phosphate. The method includes adding vaterite to the solution of disodium phosphate to create a mixture. The method includes stirring the mixture. The method includes heating the mixture. The method includes cooling the mixture. The method includes creating carbonate apatite powder.

### BACKGROUND

Currently, synthetic biomedical materials used as bone grafts contain calcium, including calcium sulfate, calcium carbonate, and calcium phosphate family (apatite, tricalcium phosphate, etc.). Carbonate apatite (CAp) is a biomineral found in bones and teeth. CAp is of the highest interest due to its excellent affinity for living organisms. CAp is a mineral and one of the building blocks of bones. This mineral has a lower crystallinity than other apatites, such as hydroxyapatite, thus allowing for alteration or modification in vivo.

However, there is presently no efficient method to synthesize CAp from phosphate-based materials using microwave radiation.

### BRIEF DESCRIPTION OF DRAWINGS

FIG. 1 is an example graph comparing X-Ray diffraction of different powders;

FIG. 2 is an example table describing X-ray diffraction intensities.

FIG. 3 is an example table describing X-ray qualitative tests;

FIG. 4 is an example graph comparing FTIR wave numbers of different powders;

FIG. 5 is an example table describing the features of FTIR wave number;

FIG. 6 is an example image of CAp at different magnifications; and

FIG. 7 is an example computing device.

### DETAILED DESCRIPTION OF PREFERRED EMBODIMENTS

The following detailed description refers to the accompanying drawings. The same reference numbers in different drawings may identify the same or similar elements.

Systems, devices, and/or methods described herein synthesize CAp from vaterite and disodium phosphate under microwave radiation, which is more efficient in terms of time, energy, and materials, and is carried out in a straightforward technique. In embodiments, the systems, methods, and/or devices described herein produce a product that has the properties of CAp through a relatively short process and at a low cost.

In embodiments, CAp can be synthesized by mixing vaterite into a solution of disodium phosphate with a specific molar composition. In embodiments, these steps are: (1) a total of 400 ml of disodium phosphate at 0.1 M is prepared; (2) a molar equivalent amount of vaterite is then mixed into the solution of disodium phosphate; (3) the mixture is stirred for 5 minutes at a rate of 240 rpm; (4) the mixture is reacted for 120 minutes under microwave radiation of medium power intensity (500 watts); (5) the suspension is rested to a temperature below 50 °C; (6) the powder is collected using Whatman paper filtration and Buchner flask and funnel; (7) on the Buchner flask, the collected powder is then rinsed with 10 ml of water at least 5 times; (8) after the final wash, the content of water is reduced by filtration over the Buchner flask for at least 15 minutes; and (9) the sediment is dried in a 37° C. oven for 24 hours.

Using this setup and composition of precursors, the CAp obtained is approximately 3.7 grams. In embodiments, the synthesis of CAp using the method in this invention produces CAp with 100% purity, according to X-ray qualitative tests.

CAp is widely used in biomedicine and currently become the standard for bone grafts due to its excellent properties. The CAp is not only biocompatible but also has a high affinity for living organisms and bioactivities, including osteoinduction and osteoconduction. In addition, CAp can adapt to the hard tissue due to its ability to reorganize the structure model. In biomedicine, CAp is used for bone grafts, bone scaffolding, and dental composite filling. a) Incorporated carbonate apatite hydrogel scaffold. (b) Cranial segment with carbonate apatite, (c) The injectable paste included carbonate apatite nanoparticles. (d) Mixed zirconia carbonate apatite deposited on dental implant, (e) 3D printed carbonate apatite scaffolds, (f) 3D printed carbonate apatite cement.

In embodiments, the synthesis of CAp from vaterite and disodium phosphate is carried out using the following protocol. First, 400 ml of disodium phosphate at a concentration of 0.1 M is prepared. Next, 4 grams of vaterite powder is added to the disodium phosphate solution. All mass measurements are performed using an analytical balance. Third, the vaterite suspension in disodium phosphate solution is stirred for 5 minutes using a magnetic stirrer at a rate of 240 rpm.

After stirring, the suspension is reacted under microwave radiation with medium power intensity (500 watts) for 120 minutes. After the completion of 120 minutes of reaction, the suspension is rested at a temperature below 50° C. Then, the powder is collected by using filtration using Whatman paper and Buchner flask and funnel. Without removing from the Buchner funnel, the powder is washed by rinsing 10 ml of water at least 5 times. After the final wash, the water content is reduced by vacuum filtration using the Buchner flask and funnel for at least 15 minutes. Finally, the powder is dried in an oven at 38±2° C. for 24 hours.

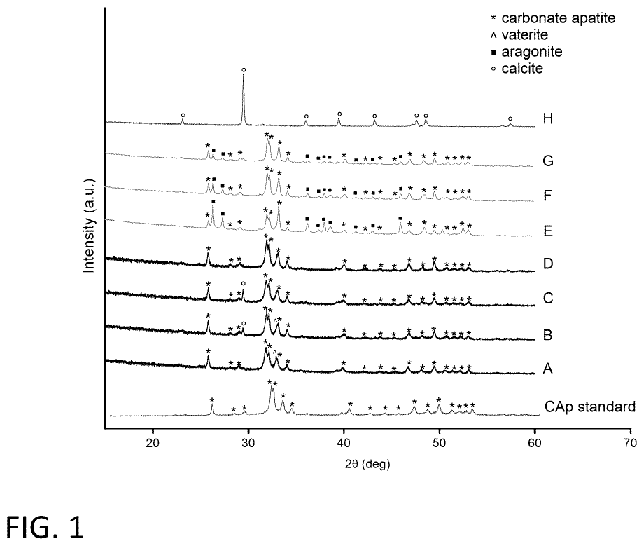

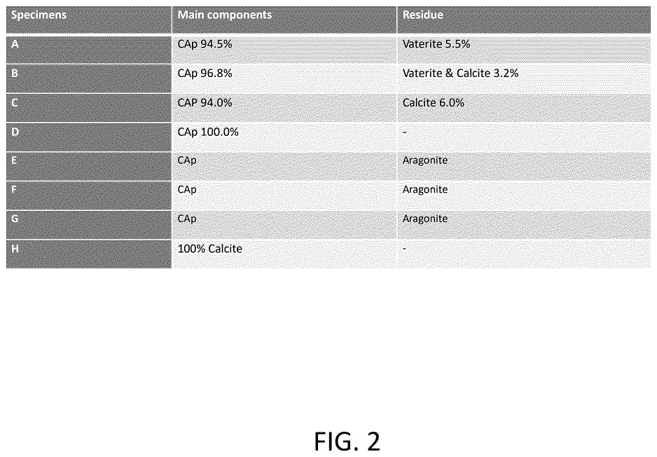

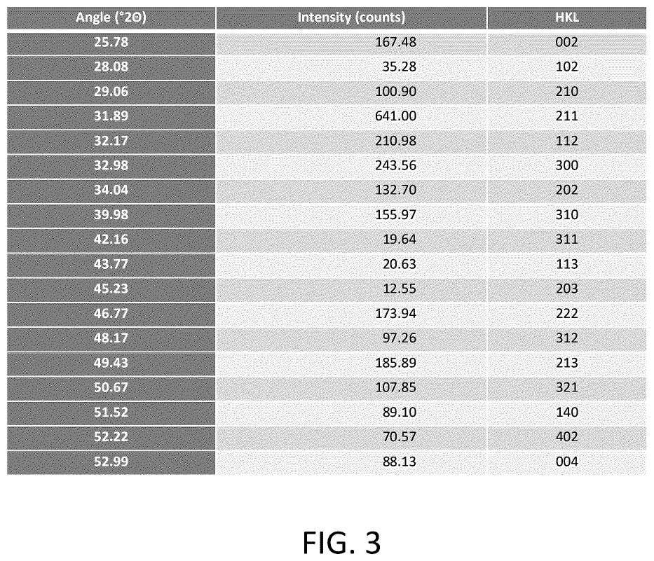

In embodiments, the yield of CAp by this method with the abovementioned amount of precursor is around 3.7 grams with 100% purity according to X-ray diffraction (XRD) analyses. In embodiments, CAp powder synthesized from vaterite and disodium phosphate through medium-intensity microwave radiation (500 watts) shows an XRD pattern that aligns with the literature and XRD databases. For comparison, powders produced from vaterite or aragonite using the same method for different durations of reaction and powder prepared from calcite instead of vaterite are shown in FIG. 1. FIG. 2 describes a table that shows details of the results shown in FIG. 1. Details of the X-ray qualitative test can be seen in the table shown in FIG. 3.

Before assays (XRD, FTIR, SEM), the synthesized powders were dried in a 37° C. oven according to the protocol in this invention and then stored in silica desiccant to avoid moisture.

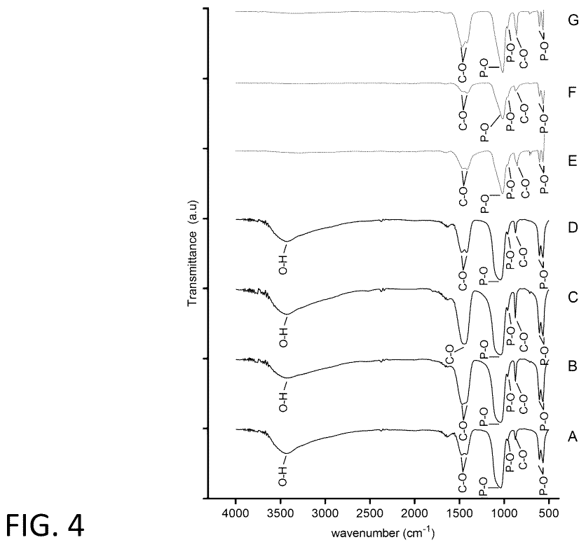

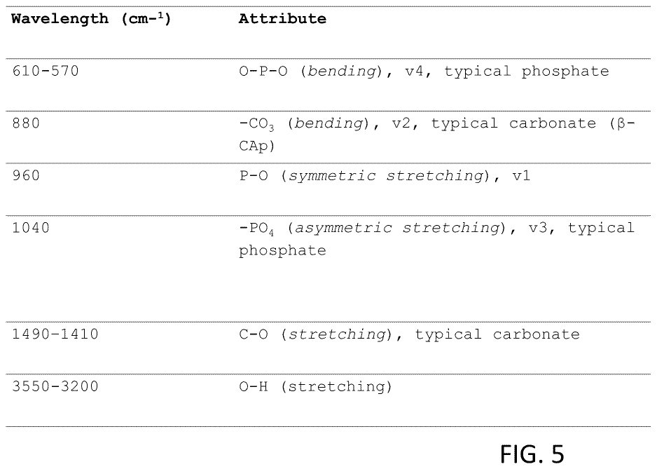

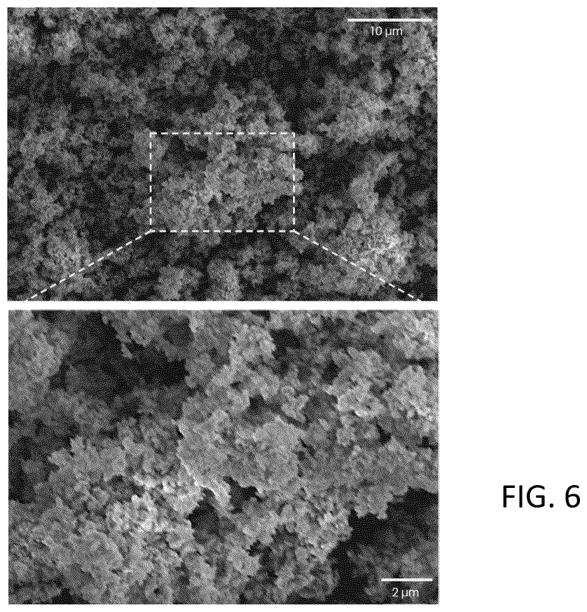

The FTIR assay shows the typical peaks of CAp, as shown in FIG. 4. FIG. 5 further describes the features shown in FIG. 4 in table format. The attribution of the functional group, which is the main characteristic of CAp, is indicated by absorption at a range of 610-570 cm⁻¹ as a marker of O-P-O bending, which shows characteristics of phosphate ions. In addition, phosphate ions are also characterized by symmetric stretching at 960 cm⁻¹ and asymmetric stretching at 1040 cm⁻¹. The carbonate group is indicated by the bending at 880 cm⁻¹ and the stretching at a range of 1490-1410 cm⁻¹. In embodiments, the bending vibration at 880 cm⁻¹ shows the characteristic of type β carbonate apatite (β-CAp). Lastly, the presence of hydroxyl groups (O—H) is indicated by wide absorption at a range of 3550-3200 cm⁻¹. The surface morphology was obtained using a scanning electron microscope (SEM) technique. The powders were gold-sputtered prior to SEM. The SEM images show that the CAp has the shape of polygonal flakes that are connected or aggregated with the adjacent particles, thus forming a large, porous and cauliflower-like structure, as shown in FIG. 6.

Microscopic representation of the specimen synthesized from vaterite and disodium phosphate under microwave radiation for 120 minutes. The morphology is in the form of polygonal flakes that are aggregated with the adjacent particles, creating large, porous and cauliflower-like structures (approximately 2-8 μm the porous between the cauliflower-like structures, ideal for cell growth).

Using a simple microwave-assisted method. Transformation of vaterite into carbonate apatite through a medium solution of 0.1 M Na₂HPO₄. Conducted at medium power (500 Watts) for 20 to 120 minutes. The resulting carbonate apatite powders are submicron and polygonal flake in shape.

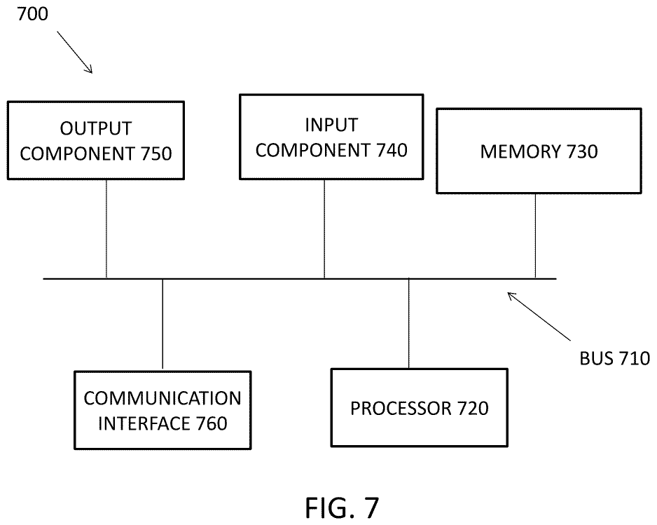

FIG. 7 is a diagram of example components of a device 700. Device 700 may correspond to one or more components of a microwave device and/or a X-ray device. In embodiments, device 700 may also be part of a spectrograph device, a computing device, or any other type of device that can generate the graphs, tables, and images as shown in FIGS. 1 to 6.

As shown in FIG. 7, device 700 may include a bus 710, a processor 720, a memory 730, an input component 740, an output component 750, and a communications interface 760. In other implementations, device 700 may contain fewer components, additional components, different components, or differently arranged components than depicted in FIG. 7. Additionally, or alternatively, one or more components of device 700 may perform one or more tasks described as being performed by one or more other components of device 700.

Bus 710 may include a path that permits communications among the components of device 700. Processor 720 may include one or more processors, microprocessors, or processing logic (e.g., a field programmable gate array (FPGA) or an application specific integrated circuit (ASIC)) that interprets and executes instructions. Memory 730 may include any type of dynamic storage device that stores information and instructions, for execution by processor 720, and/or any type of non-volatile storage device that stores information for use by processor 720. Input component 740 may include a mechanism that permits a user to input information to device 700, such as a keyboard, a keypad, a button, a switch, voice command, etc. Output component 750 may include a mechanism that outputs information to the user, such as a display, a speaker, one or more light emitting diodes (LEDs), etc.

Communications interface 760 may include any transceiver-like mechanism that enables device 700 to communicate with other devices and/or systems. For example, communications interface 760 may include an Ethernet interface, an optical interface, a coaxial interface, a wireless interface, or the like.

In another implementation, communications interface 760 may include, for example, a transmitter that may convert baseband signals from processor 720 to radio frequency (RF) signals and/or a receiver that may convert RF signals to baseband signals. Alternatively, communications interface 760 may include a transceiver to perform functions of both a transmitter and a receiver of wireless communications (e.g., radio frequency, infrared, visual optics, etc.), wired communications (e.g., conductive wire, twisted pair cable, coaxial cable, transmission line, fiber optic cable, waveguide, etc.), or a combination of wireless and wired communications.

Communications interface 760 may connect to an antenna assembly (not shown in FIG. 7) for transmission and/or reception of the RF signals. The antenna assembly may include one or more antennas to transmit and/or receive RF signals over the air. The antenna assembly may, for example, receive RF signals from communications interface 760 and transmit the RF signals over the air, and receive RF signals over the air and provide the RF signals to communications interface 760.

As will be described in detail below, device 700 may perform certain operations. Device 700 may perform these operations in response to processor 720 executing software instructions (e.g., computer program(s)) contained in a computer-readable medium, such as memory 730, a secondary storage device (e.g., hard disk, CD-ROM, etc.), or other forms of RAM or ROM. A computer-readable medium may be defined as a non-transitory memory device. A memory device may include space within a single physical memory device or spread across multiple physical memory devices. The software instructions may be read into memory 730 from another computer-readable medium or from another device. The software instructions contained in memory 730 may cause processor 720 to perform processes described herein. Alternatively, hardwired circuitry may be used in place of or in combination with software instructions to implement processes described herein. Thus, implementations described herein are not limited to any specific combination of hardware circuitry and software.

It will be apparent that example aspects, as described above, may be implemented in many different forms of software, firmware, and hardware in the implementations illustrated in the figures. The actual software code or specialized control hardware used to implement these aspects should not be construed as limiting. Thus, the operation and behavior of the aspects were described without reference to the specific software code—it being understood that software and control hardware could be designed to implement the aspects based on the description herein.

Even though particular combinations of features are recited in the claims and/or disclosed in the specification, these combinations are not intended to limit the disclosure of the possible implementations. In fact, many of these features may be combined in ways not specifically recited in the claims and/or disclosed in the specification. Although each dependent claim listed below may directly depend on only one other claim, the disclosure of the possible implementations includes each dependent claim in combination with every other claim in the claim set.

No element, act, or instruction used in the present application should be construed as critical or essential unless explicitly described as such. Also, as used herein, the article “a” is intended to include one or more items and may be used interchangeably with “one or more.” Where only one item is intended, the term “one” or similar language is used. Further, the phrase “based on” is intended to mean “based, at least in part, on” unless explicitly stated otherwise.

In the preceding specification, various preferred embodiments have been described with reference to the accompanying drawings. It will, however, be evident that various modifications and changes may be made thereto, and additional embodiments may be implemented, without departing from the broader scope of the invention as set forth in the claims that follow. The specification and drawings are accordingly to be regarded in an illustrative rather than restrictive sense.

What is claimed is:

1. A method, comprising:
preparing a solution of disodium phosphate;
adding vaterite to the solution of disodium phosphate to create a mixture;
stirring the mixture;
heating the mixture;
cooling the mixture; and
creating carbonate apatite powder.

2. The method of claim 1, wherein the solution of disodium phosphate has a concentration of 0.1 M.

3. The method of claim 1, wherein the stirring the mixture occurs at a rate of 240 rpm for a particular amount of time.

4. The method of claim 1, wherein the carbonate apatite powder has a purity level of 100%.

5. The method of claim 1, wherein the carbonate apatite powder has a polygonal flake morphology.

6. The method of claim 1, wherein the carbonate apatite (CAp) powder has particular absorption peaks via an FTIR analysis.
